(19) United States
(12) Patent Application Publication
(10) Pub. No.: US 2025/0113425 A1
(43) Pub. Date: Apr. 3, 2025

(54) Electrostatic Grounding Connection

(71) Applicant: APPLE INC., Cupertino, CA (US)

(72) Inventors: Shaowu Huang, Los Altos, CA (US); Keong W. Kam, San Jose, CA (US); Jing Li Lim, Sunnyvale, CA (US); Ramachandran Chundru, Cupertino, CA (US); Jan K. Quijalvo, San Jose, CA (US); Michael J. Woods, Sunnyvale, CA (US); Martin R. Kardasz, Mountain View, CA (US)

(21) Appl. No.: 18/806,229

(22) Filed: Aug. 15, 2024

Related U.S. Application Data
(60) Provisional application No. 63/540,949, filed on Sep. 28, 2023.

(51) Int. Cl. H05F 3/02; G06F 1/16; H01R 24/40

(52) U.S. Cl. CPC H05F 3/02; G06F 1/163; H01R 24/40

(57) ABSTRACT

A head-mounted device includes a flexible cable that electrically connects a fixed component to a movable component. The flexible cable includes a conductive shield layer that inhibits electrical interference with signals transmitted along the flexible cable. A grounding member provides a low impedance path from the shield layer to a conductive frame of the head-mounted device to reduce the likelihood and/or severity of electrostatic discharge events and/or electrostatic coupling that may affect the head-mounted device.

### CROSS-REFERENCE TO RELATED APPLICATIONS

This application claims priority to U.S. Provisional Application Ser. No. 63/540,949, filed Sep. 28, 2023, the contents of which are incorporated herein by reference.

### FIELD

The present disclosure relates generally to the field of electrical grounding for electronic devices.

### BACKGROUND

Electronic devices may include components that are sensitive to electrostatic charge. Electrostatic charge may cause electrostatic discharge events or electrostatic coupling. An electrostatic discharge event may occur when a difference between electrostatic potentials (voltage potential) of two objects (e.g., a user of the electronic device and a component of the electronic device or two components of the electronic device) exceeds a threshold, causing the electrostatic charge to be rapidly transferred between the two objects. Electrostatic coupling causes energy from one circuit to be transferred to another circuit through an electrostatic field.

### SUMMARY

One aspect of the disclosure is a head-mounted device that includes a frame, an optical module that is connected to the frame, and a control board that is fixedly connected to the frame. The optical module is configured to display content to a user wearing the head-mounted device. The head-mounted device also includes a flexible electrical connector that is electrically coupled to the optical module and to the control board. The flexible electrical connector is configured to transmit a signal between the optical module and the control board. The head-mounted device also includes a grounding member that is coupled to an outer surface of the flexible electrical connector and to the frame. Furthermore, the grounding member is configured to direct an electrical charge away from the optical module and away from the control board and toward the frame.

Another aspect of the disclosure is an electrical device that includes a discharge component, a first electronic component that is fixedly connected to the discharge component, and a second electronic component that is movably connected to the discharge component. The electrical device also includes a cable that electrically connects the first electronic component to the second electronic component. The cable includes a signal path that facilitates communication of an electrical signal between the first electronic component and the second electronic component. The cable further includes a conductive shield that surrounds the signal path and an insulating layer that is disposed between the signal path and the conductive shield. The electrical device also includes a grounding connector that is coupled to an exterior of the cable and that is electrically connected to the discharge component.

Another aspect of the disclosure is a head-mounted device that includes a housing, a chassis that is disposed within the housing, an optical module that is disposed within the housing, and a control board that is disposed within the housing. The optical module is configured to translate relative to the housing and the control board is fixed relative to the housing. The head-mounted device also includes a coaxial cable that is electrically connected to the optical module and to the control board. The coaxial cable includes a conductive core that facilitates communication of electrical information between the optical module and the control board. The coaxial cable also includes a dielectric insulator that surrounds the conductive core. The coaxial cable also includes a conductive shield layer that surrounds the dielectric insulator and protects the conductive core against electrical interference. The head-mounted device also includes an electrical connector that is coupled to an outside surface of the coaxial cable and to the chassis. The electrical connector is configured to provide a low impedance path from the coaxial cable to the chassis.

### BRIEF DESCRIPTION OF THE DRAWINGS

FIG. 1 is a front view illustration of a head-mounted device.

FIG. 2 is a top view illustration of the head-mounted device of FIG. 1.

FIG. 3 is a partial cross-sectional view illustration of the head-mounted device of FIG. 2 taken along line A-A.

FIG. 4 is a partial cross-sectional view illustration of the head-mounted device of FIG. 1 taken along line B-B and including a grounding member according to a first example.

FIG. 5 is a partial cross-sectional view illustration of the head-mounted device of FIG. 1 taken along line B-B and including a grounding member according to a second example.

FIG. 6 is a partial cross-sectional view illustration of the head-mounted device of FIG. 1 taken along line B-B and including a grounding member according to a third example.

FIG. 7A is an isometric, cross-sectional view illustration of a grounding member connected to a coaxial cable according to a first example.

FIG. 7B is an isometric, cross-sectional view illustration of a grounding member connected to a coaxial cable according to a second example.

FIG. 7C is an isometric, cross-sectional view illustration of a grounding member connected to a coaxial cable according to a third example.

### DETAILED DESCRIPTION

The disclosure herein relates to electrical grounding configurations that may reduce the likelihood and/or severity of electrostatic discharge (ESD) events and/or electrostatic coupling events on components of an electronic device. Such events may disrupt the intended performance of the electronic device by subjecting the electronic device to unwanted electromagnetic fields and electromagnetic interference (EMI).

When electrostatic charge accumulates on one component of an electronic device disproportionately to another component of the electronic device, a voltage potential between the two components increases. When a threshold voltage potential is exceeded, an ESD event may occur. The threshold voltage potential is influenced by factors such as, for example, the distance between the two components and the properties of the medium that separates the two components (e.g., moisture content in the air between the two components).

To prevent a disproportionate buildup of electrostatic charge on components of an electronic device, the components may be electrically connected to a common ground component (discharge component) via one or more low impedance paths. Such a common ground component may be a metal frame (chassis) of the electronic device or may be some other conductive component. In some implementations, the common ground component may be the Earth.

By providing low impedance paths from the components to a common ground component, electrostatic charge that accumulates on a component may be quickly (e.g., instantaneously) directed to the common ground component, whereby the electrostatic charge will be distributed throughout the common ground component as well as to other components electrically connected to the common ground component. Distributing the electrostatic charge throughout the common ground component and to components electrically connected thereto may reduce the likelihood and/or severity of electrostatic coupling. Furthermore, a voltage potential between components that are electrically connected to the common ground component via low impedance paths may be suppressed, thereby reducing the likelihood and/or severity of an ESD event.

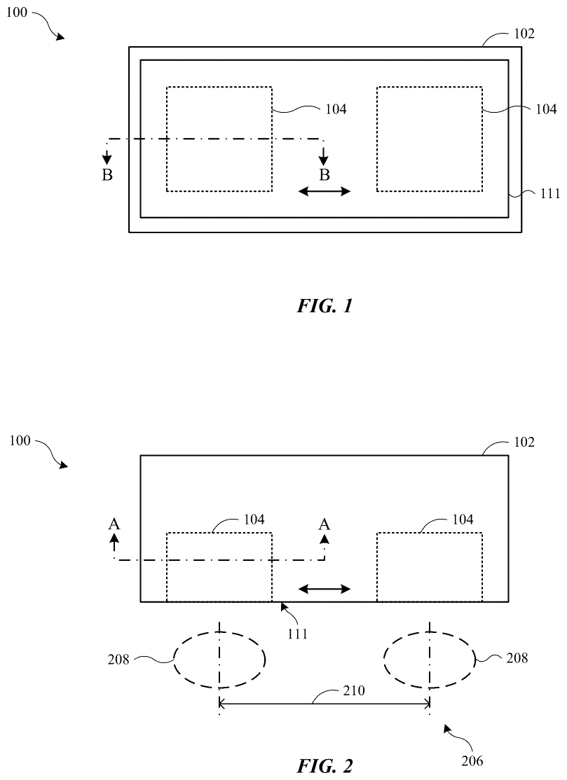

FIG. 1 is a front view illustration of a head-mounted device 100 and FIG. 2 is a top view illustration of the head-mounted device 100. The head-mounted device 100 may include a housing 102 inside which components (electronic components and non-electronic components) may be disposed or partially disposed. Among these components may include optical modules 104 (e.g., two of the optical modules 104) that are configured to display content to a user 206 of the head-mounted device 100. The user 206 has eyes 208 to which the optical modules 104 direct content. The eyes 208 are spaced by an interpupillary distance 210, and the optical modules 104 may be movable (translatable) relative to the housing 102 in order to adjust their positions according to the interpupillary distance 210. To enable the optical module 104 to translate relative to the housing 102, the housing 102 may include a compliant portion 111 through which the optical module 104 may extend.

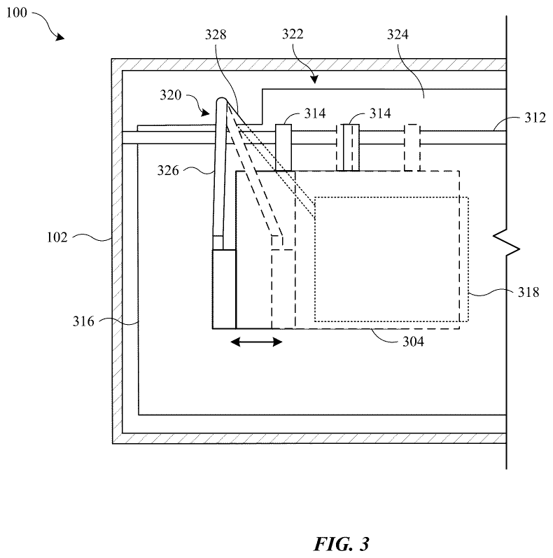

FIG. 3 is a partial cross-sectional view of the head-mounted device 100 taken along line A-A of FIG. 2, showing an optical module 304 in a first position (depicted with solid lines) and showing the optical module 304 in a second position (depicted with broken lines). The optical module 304 may be one of the optical modules 104 described above. The head-mounted device 100 may include a laterally extending member 312 that extends in a lateral direction within the housing 102 of the head-mounted device 100. The optical module 304 may include mounting features 314 that connect the optical module 304 to the laterally extending member 312. The optical module 304 may translate along the laterally extending member 312 to, for example, allow for an adjustment of the interpupillary distance 210 of the user 206. In certain implementations, the laterally extending member 312 may be a lead screw having threads, and the mounting features 314 of the optical module 304 may include complementary threads, such that rotation of the laterally extending member 312 (e.g., by an actuator) translates the optical module 304 along the laterally extending member 312. Other mechanisms may be used to move the optical module 304 with respect to the housing 102 for the purpose of interpupillary distance adjustment.

The head-mounted device 100 may include a frame 316 (e.g., a chassis). The frame 316 may support components within the housing 102 of the head-mounted device 100, such as the laterally extending member 312, and may be fixed relative to the housing 102. The optical module 304 may be electrically connected to other components of the head-mounted device 100, such as a control board 318 (depicted with dotted lines). Accordingly, the head-mounted device 100 may include a flexible cable 320 (e.g., a flexible electrical connector) that electrically connects the optical module 304 to the control board 318 in order to allow the optical module 304 to translate relative to the housing 102, the frame 316, and/or the control board 318 while maintaining an electrical connection with the control board 318.

Furthermore, as shown in FIG. 3, the frame 316 may be positioned between the optical module 304 and the control board 318 to define a first side 322 of the frame 316 that is near the control board 318 and a second side 324 of the frame 316 that is near the optical module 304. In such an implementation, the flexible cable 320 may be routed around the frame 316. Although FIG. 3 depicts the frame 316 being positioned between the optical module 304 and the control board 318, in other implementations any other component of the head-mounted device 100 may be positioned between the optical module 304 and the control board 318 rather than the frame 316. In such an implementation, the first side 322 and the second side 324 may be defined on the other component of the head-mounted device 100 rather than on the frame 316. Examples of other components that may be positioned between the optical module 304 and the control board 318 include fans, heat sinks, support structures, printed circuit boards (PCBs), the laterally extending member 312, or any other components of the head-mounted device 100. Furthermore, although the frame 316 is depicted as having an opening located on the upper, outboard area of the head-mounted device 100 through which the flexible cable 320 is routed, the frame 316 may have any shape that has any configuration of openings through/around which the flexible cable 320 may be routed.

The flexible cable 320 allows the optical module 304 to translate relative to the housing 102 while maintaining an electrical connection to the control board 318 by flexing during translation of the optical module 304. As shown in FIG. 3, during translation of the optical module 304, the flexible cable 320 may flex along a second portion 326 of the flexible cable 320 that is on the second side 324 of the frame 316, while other portions of the flexible cable 320 remain relatively undisturbed. In other implementations, during translation of the optical module 304, the flexible cable 320 may flex along other portions of the flexible cable 320, such as along a first portion 328 that is on the first side 322 of the frame 316. In other implementations, during translation of the optical module 304, the entire length of the flexible cable 320 may flex.

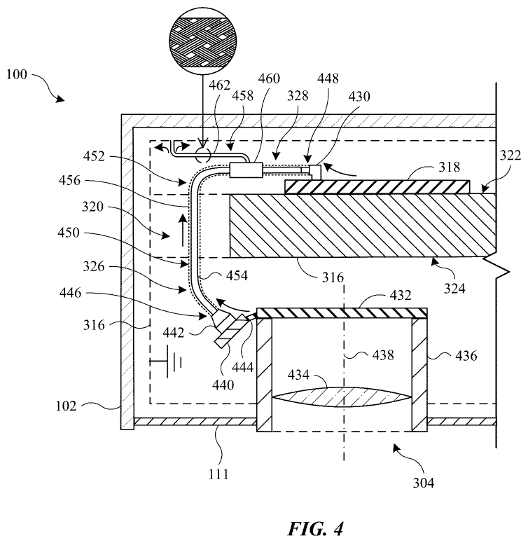

FIG. 4 is a partial cross-sectional view of the head-mounted device 100 taken along line B-B of FIG. 1 and showing the flexible cable 320 electrically connecting (electrically coupling) the optical module 304 to the control board 318. In this implementation, the control board 318 is fixed relative to the housing 102 and the frame 316. The control board 318 may include various electronic components such as a central processing unit (CPU), a graphics processing unit (GPU), random access memory (RAM), a hard disk drive (HDD), a solid-state drive (SSD), and/or integrated circuits.

The control board 318 may include a control board connector 430 that is connectable to the flexible cable 320. The control board connector 430 may have any suitable configuration that allows the flexible cable 320 to connect thereto. For example, the control board connector 430 may include any number of pins (contacts) (e.g., 5 pins, 10 pins, 20 pins, 100 pins) that are arranged in any configuration (e.g., side-by-side or as an array). The control board connector 430 may connect to the control board 318 to define a first connection orientation. For example, as shown in FIG. 4, the control board connector 430 may be a right-angle connector wherein the first connection orientation is an orientation where the control board connector 430 faces outboard of the head-mounted device 100. In other implementations, the first connection orientation may be an orientation where the control board connector 430 faces some other direction (e.g., inboard, up, down, or some other direction). In some implementations, the control board connector 430 may not be a right-angle connector (e.g., may be a vertical connector). Furthermore, the control board connector 430 may be connected to the control board 318 at any suitable location.

The control board 318 may be any suitable shape and may be positioned at any suitable orientation within the housing 102 of the head-mounted device 100. As shown in FIG. 4, the control board 318 may be supported by the frame 316 on the first side 322 of the frame 316. However, in other implementations the control board 318 may be supported by the frame 316 at another location on the frame 316, or may be supported by other components of the head-mounted device 100. The control board 318 may be secured to the frame 316 (or other component of the head-mounted device 100) via any suitable means. For example, the control board 318 may be secured to the frame 316 via one or more of threaded fasteners, adhesives, clips, or the like. Furthermore, as shown in FIG. 4, the control board 318 may be oriented such that it is substantially parallel with a back surface of the housing 102 of the head-mounted device 100. However, in other implementations, the control board 318 may have some other orientation relative to the head-mounted device 100.

The optical module 304 may include a display panel 432, a lens 434, and a bezel 436. The display panel 432 may be a light-emitting display component, such as a display screen, that is configured to display content to the user 206 that is wearing the head-mounted device 100. For example, the display panel 432 may be a liquid crystal display. As another example, the display panel 432 may be an organic light emitting diode (OLED) display. As another example, the display panel 432 may be a liquid crystal on silicon (LCoS) micro display.

The lens 434 is configured to direct content from the display panel 432 to one of the eyes 208 of the user 206 to allow the user 206 to view the content. The lens 434 may be coupled to the display panel 432 by the bezel 436. The bezel 436 may be configured to support the lens 434 relative to the display panel 432 and to limit motion of the lens 434 relative to the display panel 432. As shown in FIG. 4, in some implementations, the bezel 436 may be substantially tubular and may define an optical axis 438 that extends therethrough. The display panel 432 and the lens 434 may be spaced along the optical axis 438. Light emitted by the display panel 432 may travel generally along the optical axis 438 of the bezel 436 from the display panel 432 to the lens 434, whereby the light passes through the lens 434 and to one of the eyes 208 of the user 206.

The optical module 304 may also include an optical module control board 440. The optical module control board 440 may be electrically connected to the display panel 432 and may be configured to provide a signal to the display panel 432 (e.g., to provide the content to the display panel 432). For example, the display panel 432 may be configured to show the content based on the signal received from the optical module control board 440. In some implementations, the optical module control board 440 may include one or more integrated circuits, memory components, or other electronic components, such as those described above with respect to the control board 318.

The optical module control board 440 may also include an optical module connector 442 that is connectable to the flexible cable 320. Similar to the control board connector 430, the optical module connector 442 may have any suitable configuration and may be located at any suitable location on the optical module control board 440. Furthermore, similar to the control board connector 430, the optical module connector 442 may be connected to the optical module control board 440 to define a second connection orientation. As shown in FIG. 4, the second connection orientation may be an orientation where the optical module connector faces in a rear, outboard direction of the head-mounted device 100. However, in other implementations, the second connection orientation may be an orientation where the optical module connector 442 faces some other direction (e.g., inboard, up, down, or some other direction).

The optical module 304 may also include a flexible connector 444 that is configured to electrically connect the display panel 432 to the optical module control board 440. The flexible connector 444 may allow the optical module control board 440 to provide a signal to the display panel 432. For example, the optical module control board 440 may be configured to provide the signal for the content to the display panel 432 via the flexible connector 444. The flexible connector 444 may be flexible in order to further enable the optical module 304 to translate while maintaining an electrical connection between the control board 318 and the display panel 432. In some implementations, the flexible connector 444 may be a flexible flat cable, a flexible printed circuit, a flexible ribbon cable, or any other electrical connector suitable to facilitate a flexible connection between the optical module control board 440 and the display panel 432.

The flexible cable 320 may include a first connector portion 446 configured to connect to the optical module connector 442, a second connector portion 448 configured to connect to the control board connector 430, and a cable portion 450 extending therebetween. As shown in FIG. 4, the cable portion 450 may be routed around the frame 316 to define a bend 452. The bend 452 may aid in routing the flexible cable 320 around the frame 316. Furthermore, as described above, the control board connector 430 and the optical module connector 442 may be positioned at a first connection orientation and a second connection orientation, respectively, wherein the first connection orientation and the second connection orientation are different. Thus, the bend 452 may also aid in orienting the first connector portion 446 of the flexible cable 320 to be consistent with the second connection orientation of the optical module connector 442, and may aid in orienting the second connector portion 448 of the flexible cable 320 to be consistent with the first connection orientation of the control board connector 430. Although the bend 452 is depicted as being located at a rear, outboard area of the head-mounted device 100, it will be readily understood that the bend 452 may not be located at a specific location along the flexible cable 320 and may instead change locations along the flexible cable 320 during operation of the head-mounted device 100 (e.g., during translation of the optical module 304). Furthermore, the bend 452 may be located in other areas of the head-mounted device 100 depending on the positions of the frame 316, the optical module 304, the control board 318, and/or other components of the head-mounted device 100.

The flexible cable 320 includes a signal path 454 that is configured to transmit (e.g., is configured to facilitate communication of) an electrical signal between the optical module 304 and the control board 318. The electrical signal may be electrical information related to operation of the display panel 432 (e.g., may be a signal for the content) or may be other electrical information related to other operations of the head-mounted device 100. The flexible cable 320 may also include a conductive shield 456 that is configured to prevent (reduce) EMI with the electrical signal as it is transmitted along the signal path 454 between the optical module 304 and the control board 318.

In certain implementations, the conductive shield 456 may be electrically connected to the optical module 304 and to the control board 318 to provide a low impedance path between the optical module 304 and the control board 318 as shown using directional arrows. The low impedance path provided by the conductive shield 456 may allow for electrostatic charge (electrical charge) to be transferred between the optical module 304 and the control board 318. In such an implementation, the optical module connector 442 may be configured to provide separate electrical paths between the optical module 304 and the signal path 454 through which the electrical signal may be communicated and between the optical module 304 and the conductive shield 456 though which electrostatic charge may travel. Likewise, the control board connector 430 may provide separate electrical paths between the control board 318 and the signal path 454 and between the control board 318 and the conductive shield 456. By providing a low impedance path between the optical module 304 and the control board 318 through which electrostatic charge may travel, a voltage potential between the optical module 304 and the control board 318 may be suppressed.

The head-mounted device 100 may further include a grounding member 458 (a grounding connector) that electrically connects the conductive shield 456 of the flexible cable 320 to a common ground component of the head-mounted device 100. In certain implementations, the common ground component may be the frame 316. In other implementations, the common ground component may be some other conductive component of the head-mounted device 100. By electrically connecting the conductive shield 456 to the frame 316, the grounding member 458 may provide a low impedance path between the conductive shield 456 and the frame 316 through which electrostatic charge (electrical charge) may travel. Therefore, in such an implementation, the conductive shield 456 of the flexible cable 320 and the grounding member 458 may cooperatively provide low impedance paths from the optical module 304 to the frame 316 and from the control board 318 to the frame 316. By providing low impedance paths from the optical module 304 to the frame 316 and from the control board 318 to the frame 316, the grounding member 458 may direct electrostatic charge (electrical charge) away from the optical module and away from the control board and toward the frame.

Although the above discusses the conductive shield 456 and the grounding member 458 cooperatively providing low impedance paths from both the optical module 304 and the control board 318 to the frame 316, in other implementations the conductive shield 456 and the grounding member 458 may only provide a low impedance path from either the optical module 304 to the frame 316, or from the control board 318 to the frame 316. In such implementations, the conductive shield 456 may be electrically connected to only one of the optical module 304 or the control board 318.

The grounding member 458 may include a collar 460 and a cable 462. The collar 460 is conductive (e.g., is a conductive collar) and may be electrically connected to the conductive shield 456 of the flexible cable 320. The cable 462 may electrically connect the collar 460 to the frame 316. The cable 462 of the grounding member 458 is comprised of a conductive material (e.g., copper, aluminum, steel, brass) to allow electrostatic charge (electrical charge) to travel thereon. Furthermore, in certain implementations, the cable 462 may be flexible in order to flex with the flexible cable 320 during operation of the head-mounted device 100 (e.g., during translation of the optical module 304). In implementations where the cable 462 is flexible, the cable 462 may include braided conductive strands (e.g., strands of a conductive material that are arranged in a braided configuration). The braided conductive strands may be comprised of a conductive material (e.g., copper, aluminum, steel, brass). The braided conductive strands may enable the cable 462 to withstand repeated cycles of flexion (e.g., 1,000 cycles, 10,000 cycles, 100,000 cycles) without substantial degradation or mechanical failure. In other implementations, however, the cable 462 may be comprised of some other configuration of a conductive material. For example, the cable 462 may be comprised of a single wire or may be comprised of multiple wires. In implementations where the cable 462 is comprised of multiple wires, the multiple wires may be twisted around one-another. The cable 462 may be electrically connected to the frame 316 via any suitable means that allow for a low impedance path to be maintained therebetween during operation of the head-mounted device 100. For example, the cable 462 may be electrically connected to the frame 316 via one or more of fasteners, clips, or the like.

As shown in FIG. 4, in some implementations, the collar 460 may be connected to the conductive shield 456 along the first portion 328 of the flexible cable 320, and the cable 462 may be connected to the frame 316 at a rear, outboard location of the frame 316 adjacent to the housing 102. As described above with reference to FIG. 3, the first portion 328 of the flexible cable 320 may remain relatively undisturbed during translation of the optical module 304. Thus, by positioning the collar 460 along the first portion 328 of the flexible cable 320, an amount of movement that the collar 460 is subjected to during translation of the optical module 304 may be reduced as compared to implementations where the collar 460 is positioned at other locations along the flexible cable 320. Furthermore, reducing movement of the collar 460 during translation of the optical module 304 may also reduce an amount of flexion that the cable 462 is subjected to during translation of the optical module 304 as compared to implementations where the collar 460 is positioned at other locations along the flexible cable 320. In some implementations, the collar 460 may be connected to the conductive shield 456 along the cable portion 450 of the flexible cable 320 between the bend 452 and the control board 318.

In addition to providing a low impedance path between the conductive shield 456 and the frame 316, the grounding member 458 may also be configured to retain portions of the flexible cable 320 to the frame 316. By retaining portions of the flexible cable 320 to the frame 316, the grounding member 458 may aid in routing the flexible cable 320 within the head-mounted device 100. In certain implementations, the grounding member 458 may define the location of the bend 452 of the flexible cable 320. Additionally, by retaining portions of the flexible cable 320 to the frame 316, the grounding member 458 may influence which portions of the flexible cable 320 flex during translation of the optical module 304. For example, in certain implementations, the collar 460 may be connected to the first portion 328 of the flexible cable 320 and the cable 462 may retain the first portion 328 to the frame 316. During translation of the optical module 304, the first portion 328 of the flexible cable 320 may be held relatively still by the grounding member 458 while other portions of the flexible cable 320 (e.g., the second portion 326 and/or the bend 452) flex to accommodate the movement of the optical module 304.

Although FIG. 4 depicts the collar 460 positioned along the first portion 328 of the flexible cable 320, the collar 460 may be positioned at any suitable location along the flexible cable 320 that allows the optical module 304 to translate while maintaining a low impedance path between the conductive shield 456 and the frame 316. Likewise, although FIG. 4 depicts the cable 462 connected to the frame 316 at a certain location adjacent to the housing 102, the cable 462 may be connected to the frame 316 at any suitable location that allows the optical module 304 to translate while maintaining a low impedance path between the conductive shield 456 and the frame 316.

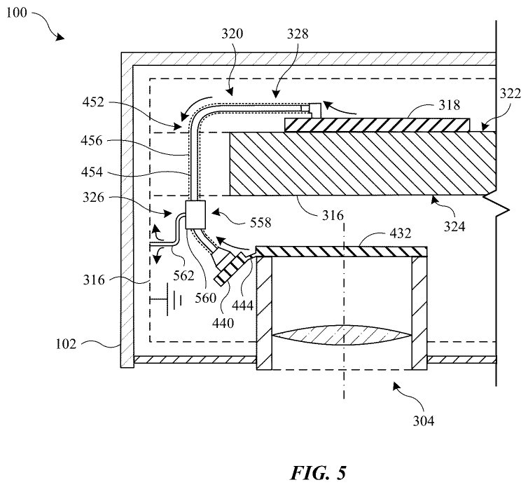

FIG. 5 is a partial cross-sectional view of the head-mounted device 100 taken along line B-B of FIG. 1 and showing another implementation of a grounding member 558. The grounding member 558 may be similar to the grounding member 458 except as described herein. In this implementation, a collar 560 is connected to the conductive shield 456 along the second portion 326 of the flexible cable 320, and a cable 562 connects the collar 560 to the frame 316 at a medial, outboard location of the frame 316 adjacent to the housing 102. In some implementations, the collar 560 may be connected to the conductive shield 456 along the cable portion 450 of the flexible cable 320 between the bend 452 and the optical module 304.

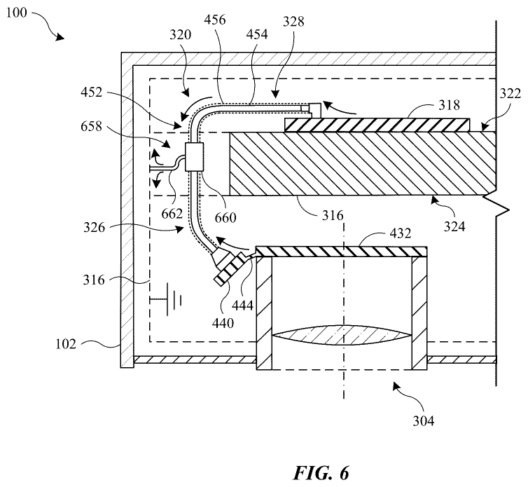

FIG. 6 is a partial cross-sectional view of the head-mounted device 100 taken along line B-B of FIG. 1 and showing another implementation of a grounding member 658. The grounding member 658 may be similar to the grounding member 458 except as described herein. In this implementation, a collar 660 is connected to the conductive shield 456 along the bend 452 of the flexible cable 320, and a cable 662 connects the collar 660 to the frame 316 at another medial, outboard location of the frame 316 adjacent to the housing 102.

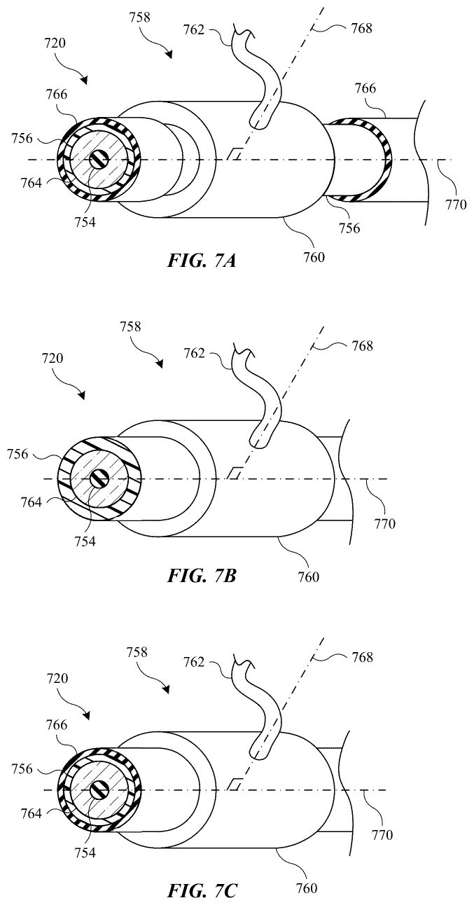

FIG. 7A-7C are isometric, cross-sectional views of implementations of a grounding member 758 connected to a flexible cable 720. The grounding member 758 may be similar to the grounding members 458, 558, or 658, and the flexible cable 720 may be similar to the flexible cable 320, except as described herein. In certain implementations, the flexible cable 720 may be a coaxial cable that includes a signal path 754 (e.g., a conductive core), an insulating layer 764, and a conductive shield 756 (e.g., a conductive shield layer). In some implementations, the flexible cable 720 may be a micro-coaxial cable (e.g., a coaxial cable having an outer diameter less than 1.2 mm) that includes the same components as described above with respect to a coaxial cable. In some implementations (such as those shown in FIGS. 7A and 7C), the flexible cable 720 may also include an outer jacket 766. The signal path 754 may be similar to the signal path 454, and the conductive shield 756 may be similar to the conductive shield 456, except as described herein.

The signal path 754 (e.g., the conductive core) may be comprised of a single wire (e.g., an elongated conductor) or may be comprised of multiple wires (e.g., multiple elongated conductors) that are twisted around one-another. The signal path may be comprised of any conductive material (e.g., copper, aluminum, steel, brass) that may allow the electrical signal to transmitted thereon. In implementations where the signal path is comprised of multiple wires that are twisted around one-another, each of the wires may include insulation on the outer surface of the wires such that the wires are insulated relative to each other. Furthermore, in some implementations, the signal path 754 may be comprised of multiple micro-coaxial cables, each including a conductive core, an insulating layer, a shield layer, and a nonconductive outer jacket. In such an implementation, the micro-coaxial cables may be twisted around one-another, wherein the outer jacket of each of the micro-coaxial cables may insulate each of the micro-coaxial cables relative to each other.

The insulating layer 764 may extend concentrically around (e.g., surround) the signal path 754. In some implementations, the insulating layer 764 may be comprised of a dielectric material (e.g., may be a dielectric insulator), such as PTFE, polyethylene, or some other dielectric material. The insulating layer 764 may insulate the signal path 754 from the conductive shield 756 to inhibit the electrical signal and/or electrostatic charge from traveling therebetween. The insulating layer 764 may also be operable to prevent a loss of the electrical signal while it is transmitted along the signal path 754.

The conductive shield 756 (e.g., the conductive shield layer) may be comprised of an elongated conductor that extends concentrically around (e.g., surrounds) the insulating layer 764. In some implementations, the conductive shield 756 may be comprised of strands of the conductive material (e.g., copper, aluminum, steel, brass) that extend around the insulating layer 764 in a braided configuration. In other implementations, the conductive shield 756 may be comprised of strands of the conductive material that extend around the insulating layer 764 in a spiral configuration. In yet other implementations, the conductive material may be a unitary sheet (e.g., foil or tape) that extends around the insulating layer 764. As described above with reference to FIG. 4, the conductive shield 756 may be configured to prevent (reduce) EMI with the electrical signal as it is transmitted along the signal path 454 by reflecting and/or absorbing EMI that may otherwise interfere with the electrical signal (e.g., that may otherwise cause noise in the electrical signal).

The outer jacket 766 may extend concentrically around (e.g., surround) the conductive shield 756. In some implementations, the outer jacket 766 may be nonconductive (e.g., may be a nonconductive outer jacket), wherein the outer jacket 766 may be comprised of an insulating material (e.g., PVC or polyethylene). However, in other implementations described in further detail below, the outer jacket 766 may be conductive (e.g., may be a conductive outer jacket), wherein the outer jacket 766 may be comprised of a conductive material through which electrostatic charge (electrical charge) may travel.

In implementations where the outer jacket 766 is nonconductive, the outer jacket 766 may insulate the conductive shield 756 from other components of the head-mounted device 100 that the flexible cable 720 may contact. Thus, in implementations where the conductive shield 756 provides a low impedance path through which electrostatic charge (electrical charge) may travel, the outer jacket 766 may inhibit the electrostatic charge from traveling between the conductive shield 756 and other components of the head-mounted device 100. Additionally, the outer jacket 766 may protect the conductive shield 756, and other components of the flexible cable 720, from physical damage. For example, the outer jacket 766 may prevent the flexible cable 720 from becoming pinched during operation of the head-mounted device 100 (e.g., during translation of the optical module 304).

The collar 760 of the grounding member 758 may be substantially cylindrical (tubular) such that the collar 760 may extend concentrically around (e.g., surround) an entire outer diameter of the flexible cable 720, or components thereof, to contact an outer surface (e.g., an outside surface or exterior) of the flexible cable 720. In other implementations, the collar 760 may only be a section of a cylinder that extends concentrically around only a portion of the outer diameter the flexible cable 720, or components thereof (e.g., may be semi-cylindrical). In implementations where the collar 760 is substantially cylindrical or semi-cylindrical, the collar 760 may include a hinge portion (not expressly shown) that enables the collar 760 to be opened and positioned along the flexible cable 720. In other implementations, the collar 760 may be a conductive clip that includes an opening configured to receive the flexible cable 720.

As described with respect to the collar 460 of FIG. 4, the collar 760 is conductive (e.g., is a conductive collar) to enable an electrical connection between the conductive shield 756 of the flexible cable 720 and the cable 762. The collar 760 may be comprised of any configuration of any conductive material that facilitates a low impedance path between the conductive shield 756 and the cable 762. For example, the collar 760 may include a conductive material (e.g., copper, aluminum, steel, brass) on an inner surface of the collar 760 that contacts an outer surface of the conductive shield 756, and may include an insulative material on an outer surface of the collar 760. As another example, the collar 760 may be comprised entirely of a conductive material.

The cable 762 of the grounding member 758 may be connected to the collar 760 to define a connection axis 768. As shown in FIG. 7A, in some implementations, the cable 762 may connect to the collar 760 at an angle such that the connection axis 768 relative to a longitudinal axis 770 of the collar 760 is substantially perpendicular. In other implementations, however, the cable 762 may be connected to the collar 760 such that the connection axis 768 is not perpendicular to the longitudinal axis 770 of the collar 760, but is rather some other angle (e.g., 15 degrees, 30 degrees, 45 degrees, 75 degrees, 135 degrees) relative to the longitudinal axis 770.

As shown in FIG. 7A, in order for the collar 760 of the grounding member 758 to electrically connect to the conductive shield 756, a portion of the outer jacket 766 may be omitted (removed). However, as shown in FIG. 7B, in some implementations, the flexible cable 720 may omit the outer jacket 766 altogether. In implementations where the flexible cable 720 includes the outer jacket 766, the collar 760 may include piercing members (prongs) that extend radially inward (not expressly shown) and that are configured to pierce the outer jacket 766 to contact the conductive shield 756.

FIG. 7C shows an implementation where the collar 760 of the grounding member 758 contacts an outer surface of the outer jacket 766 rather than an outer surface of the conductive shield 756. In this implementation, the grounding member 758 may function to prevent an electrostatic charge from accumulating on a non-conductive outer surface of the outer jacket 766.

In some implementations, the outer jacket 766 may be comprised of a conductive material (e.g., embedded conductive particles or fibers) through which electrostatic charge (electrical charge) may travel. In some implementations, the outer jacket 766 may be comprised of a non-conductive material that is coated with a conductive coating layer through which electrostatic charge (electrical charge) may travel. In such implementations, similar to the conductive shield 756 as described above, the outer jacket 766 may provide a low impedance path between the control board 318 and the frame 316, and/or between the optical module 304 and the frame 316. In such an implementation, the outer jacket 766 may be electrically connected to the control board 318 and/or the optical module 304 such that electrostatic charge may be transferred therebetween.

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create three-dimensional or spatial audio environment that provides the perception of point audio sources in three-dimensional space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end.

In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

As described above, one aspect of the present technology is the gathering and use of data available from various sources for use during operation of the head-mounted device 100. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores historical use information that allows the optical module 104 to be adjusted according to the interpupillary distance 210 of the user 206. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for adjustment of the optical modules 104 according to the interpupillary distance 210 of the user 206, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the interpupillary distance 210 of the user 206 may be determined each time the head-mounted device 100 is used, such as by using sensors to measure the interpupillary distance 210, and without subsequently storing the information or associating with the particular user.

What is claimed is:

1. A head-mounted device, comprising:
a frame;
an optical module connected to the frame, the optical module configured to display content to a user wearing the head-mounted device;
a control board fixedly connected to the frame;
a flexible electrical connector electrically coupled to the optical module and to the control board, the flexible electrical connector configured to transmit a signal between the optical module and the control board; and
a grounding member coupled to an outer surface of the flexible electrical connector and to the frame, wherein the grounding member is configured to direct an electrical charge away from the optical module, away from the control board, and toward the frame.

2. The head-mounted device of claim 1, wherein the outer surface of the flexible electrical connector is defined by a conductive shield layer.

3. The head-mounted device of claim 1, wherein the outer surface of the flexible electrical connector is defined by a nonconductive outer jacket.

4. The head-mounted device of claim 1, wherein:
the flexible electrical connector comprises a first elongated conductor and a second elongated conductor,
the first elongated conductor is configured to transmit the signal between the optical module and the control board, and
the second elongated conductor is configured to prevent electrical interference with the signal as it is transmitted between the optical module and the control board.

5. The head-mounted device of claim 1, wherein:
the flexible electrical connector includes a first connector portion that is connected to the optical module at a first connection orientation, a second connector portion that is connected to the control board at a second connection orientation that is different than the first connection orientation, and a cable portion that is located between the first connector portion and the second connector portion, and
the cable portion of the flexible electrical connector defines a bend to orient the first connector portion according to the first connection orientation and to orient the second connector portion according to the second connection orientation.

6. The head-mounted device of claim 5, wherein the grounding member is coupled to the cable portion of the flexible electrical connector between the bend and the optical module.

7. The head-mounted device of claim 5, wherein the grounding member is coupled to the cable portion of the flexible electrical connector between the bend and the control board.

8. The head-mounted device of claim 1, wherein the grounding member includes:
a collar that surrounds a portion of the flexible electrical connector, and
a cable that connects the collar to the frame.

9. The head-mounted device of claim 8, wherein the collar is substantially cylindrical, and the cable is connected to the collar at an angle that is substantially perpendicular to a longitudinal axis of the collar.

10. The head-mounted device of claim 8, wherein the cable includes braided conductive strands.

11. The head-mounted device of claim 1, wherein the optical module is configured to move laterally relative to the frame.

12. The head-mounted device of claim 11, wherein movement of the optical module laterally relative to the frame allows adjustment of an interpupillary distance.

13. An electrical device, comprising:
a discharge component;
a first electronic component that is fixedly connected to the discharge component;
a second electronic component that is movably connected to the discharge component;
a cable electrically connecting the first electronic component to the second electronic component, the cable comprising:
a signal path facilitating communication of an electrical signal between the first electronic component and the second electronic component,
a conductive shield surrounding the signal path, and
an insulating layer disposed between the signal path and the conductive shield; and
a grounding connector coupled to an exterior of the cable and electrically connected to the discharge component.

14. The electrical device of claim 13, further comprising:
a frame positioned between the first electronic component and the second electronic component, the frame having a first side that is near the first electronic component and a second side that is near the second electronic component, wherein the cable is routed around the frame to define a first portion of the cable that on the first side of the frame and to define a second portion of the cable that is on the second side of the frame.

15. The electrical device of claim 14, wherein the grounding connector is coupled to the first portion of the cable.

16. The electrical device of claim 14, wherein the grounding connector is coupled to the second portion of the cable.

17. The electrical device of claim 13, wherein:
the signal path comprises an elongated conductor;
the insulating layer extends concentrically around the elongated conductor; and
the conductive shield extends concentrically around the insulating layer.

18. The electrical device of claim 13, wherein the grounding connector comprises:
a conductive collar that surrounds a portion of the cable; and
a grounding member that electrically connects the conductive collar to the discharge component.

19. The electrical device of claim 18, wherein the cable further comprises an outer jacket that surrounds the conductive shield.

20. A head-mounted device comprising:
a housing;
a chassis disposed within the housing;
an optical module disposed within the housing, wherein the optical module is configured to translate relative to the housing;
a control board disposed within the housing, wherein the control board is fixed relative to the housing;
a coaxial cable electrically connected to the optical module and to the control board, the coaxial cable comprising:
a conductive core that facilitates communication of electrical information between the optical module and the control board,
a dielectric insulator that surrounds the conductive core, and
a conductive shield layer that surrounds the dielectric insulator and protects the conductive core against electrical interference; and
an electrical connector coupled to an outside surface of the coaxial cable and to the chassis, wherein the electrical connector is configured to provide a low impedance path from the coaxial cable to the chassis.
